(19) United States
(12) Patent Application Publication
(10) Pub. No.: US 2003/0106411 A1
(43) Pub. Date: Jun. 12, 2003

(54) Electric stringed musical instrument having fastener shared between frame body and strap

(76) Inventors: Kiyoshi Minakuchi, Shizuoka (JP); Akio Naniki, Shizuoka (JP); Katsuya Suzuki, Shizuoka (JP)

Correspondence Address: DICKSTEIN SHAPIRO MORIN & OSHINSKY LLP, Steven I. Weisburd, 41st Floor, 1177 Avenue of the Americas, New York, NY, 10036-2714, US

(21) Appl. No.: 10/292,767

(22) Filed: Nov. 13, 2002

(30) Foreign Application Priority Data
Nov. 19, 2001 (JP) 2001-352955 PAT.

(51) Int. Cl. G10D 3/00; G10G 5/00

(52) U.S. Cl. 84/327

(57) ABSTRACT

An electric stringed instrument has a frame body the contour of which is like the outline of a solid body of a corresponding electric or acoustic stringed instrument; the frame body is constituted by plural frame pieces, and the frame piece is detachably connected to a trunk of the electric stringed instrument; a user slings the electric stringed instrument over his or her shoulder by means of a strap so that the strap is to be connected to the trunk by means of fasteners; the fasteners are further used for securing the frame piece to the trunk so that the frame pieces are not unintentionally dropped out from the trunk without increasing the fasteners.

### FIELD OF THE INVENTION

This invention relates to an electric stringed musical instrument and, more particularly, to an electric stringed musical instrument having a frame separable from a trunk over which strings are stretched.

### DESCRIPTION OF THE RELATED ART

Electric guitars belong to the electric stringed musical instrument. Players usually sling the electric guitars over their shoulders with straps, and pluck the strings so as to give rise to vibrations of the strings. The vibrations of the strings are converted to electric signals by means of pickup units, and the electric tones are radiated from the associated sound systems.

Various sorts of electric guitars have been sold in the market. Electric guitars with solid bodies have been popular to the guitarists. The electric guitar has a solid body, and a neck projects from the solid body. Strings are stretched over the neck, and a pickup unit is provided under the strings. The solid body is made from a wood panel or of synthetic resin, and silver fir or spruce is preferable for the solid body. Although several sorts of solid bodies are formed with hollow spaces, the hollow spaces are not expected to serve as resonators, because the amplifiers increase the loudness of the electric tones.

Nevertheless, some electric guitars have bodies formed with resonators, and are called as “electric acoustic guitar”. In this instance, the non-solid body is assembled from deck boards and a sideboard. The deck boards and sideboard define the resonator, and a center block of maple reinforces the non-slid body.

The electric guitars are equipped with electromagnetic pickup units, and the electromagnetic pickup units convert the vibrations of steel strings to the electric signals. Pressure-sensitive pickup units may be employed for other electric guitars. In this instance, nylon strings or gut strings may extend over the pressure-sensitive pickup units.

Those bodies, pickup units and strings form a wide variety of electric guitars. As described hereinbefore, the resonators are not required for the electric guitars with the exception of the electric acoustic guitars. Frame bodies have been proposed for the electric guitars. The frame bodies are so light that guitarists feel the electric guitars easy to keep them around the waists.

FIG. 1 shows a typical example of the frame body 1 forming a part of the electric guitar 2. The electric guitar 2 further comprises a trunk 3 and strings 4. The trunk 3 serves as a boss 3a and a neck 3b. The frame 1 sideward expands from the boss 3a, and frets 5 are embedded in the neck 3b at intervals. The strings 4 are made of nylon. The strings 4 are stretched over the frets 5 and a bridge 6a, and are terminated at a tailpiece 6b and pegs (not shown). The boss 3a is formed with a peg box 3c, and pegs 7 are rotatably supported by the peg box 3c. The strings 4 are anchored to the pegs 7, respectively, and the user gives the tension to the strings 4 by winding the strings 4 around the pegs 7.

Three frame pieces 1a, 1b and 1c form in combination the frame body 1, and make users to image the outline of the conventional guitar body. The frame pieces 1a and 1b are attached to the left side of the trunk 3, and the other frame piece 1c is attached to the right side of the trunk 3. A strap S is connected to the trunk 3 by means of couplers C, and the user slings the electric guitar 2 over the shoulder by using the strap S. The strap is connected to the trunk 3 by means of couplers.

Plugs 8 are fixed to both ends of each frame piece 3a/ 32b/3c, and sleeves 9 are embedded in the trunk 3 as shown in FIG. 2. The sleeves 9 are open to the outside on the side surfaces of the trunk 3. When the user assembles the frame pieces 1a/1b/1c with the trunk 3, he or she pushes the plugs 8 into the sleeves 9. Friction takes place between the outer surfaces of the plugs 8 and the inner surfaces of the sleeves 9, and keeps the plugs 8 in the sleeves 9. On the other hand, when the user disassembles the frame body 1 from the trunk 3, he or she pulls out the plugs 8. Thus, the electric guitar 2 is separable into frame pieces 1a/1b/1c and trunk 3.

The detachable frame body 3 is desirable for the users, because the parts 1a/1b/1c/3 are received in a small case. However, a problem is encountered in the prior art electric guitar 2 in that the frame pieces 1a/1b/1c tend to be dropped out from the trunk 3 in the performance. When the user wants to get ready to play the electric guitar 2, he or she assembles the frame pieces 1a/1b/1c with the trunk 3. When the user finishes the practice, he or she disassemble the frame pieces 1a/1b/1c from the trunk 3, and puts the parts 1a/1b/1c/3 in the case. The plugs 8 are pushed into the sleeves 9 and pulled out at every practice and performance. The plugs 8 and sleeves 9 are worn out, and, accordingly, the friction is reduced. As a result, the frame pieces 1a/1b/1c are liable to be dropped out from the trunk 3 in the practice or performance.

### SUMMARY OF THE INVENTION

It is therefore an important object of the present invention to provide an electric stringed instrument which is simple in outer appearance and not unintentionally separated into parts.

The inventors contemplated the problem inherent in the electric stringed instrument of the type having the frame body, i.e., the electric guitar. The inventors firstly pressed the plugs 8 to the trunk 3 by means of bolts. The trunk 3 was jammed with the frame pieces 1a/1b/1c, couplers C and bolts. The frame pieces 1a/1b/1c were implanted into the trunk 3 at the six points on the trunk 3, the plugs were pressed to the trunk 3 with the bolts, and the strap S were anchored at both ends to the trunk 3 by means of the couplers C. The frame pieces 1a/1b/1c, bolts and couplers C occupied the respective areas on the trunk 3, and the users felt the electric guitar disgraceful.

To accomplish the object, the present invention proposes to share fasteners between a frame body and a strap.

In accordance with one aspect of the present invention, there is provided a stringed musical instrument slung over a shoulder of a player for playing a piece of music comprising a trunk having plural surfaces, at least one string stretched over one of the plural surfaces between both end portions of the trunk, a frame body having end portions inserted into recesses formed in the trunk and open to the outside on selected ones of the plural surfaces, a strap making the player sling the stringed musical instrument over the shoulder, and fasteners shared between the frame body and the strap for securing the end portions and both end portions of the strap to the trunk.

### BRIEF DESCRIPTION OF THE DRAWINGS

The features and advantages of the electric stringed instrument will be more clearly understood from the following description taken in conjunction with the accompanying drawings, in which

FIG. 1 is a front view showing the structure of the prior art electric guitar,

FIG. 2 is a cross sectional view showing the plug and sleeve used for connecting the frame pieces to the trunk,

FIG. 3 is a perspective view showing an electric guitar according to the present invention,

FIG. 4 is a cross sectional view showing a fastener shared between a frame body and a strap,

FIGS. 5 and 6 are cross sectional views showing a plug of a frame piece incorporated in another electric stringed instrument according to the present invention,

FIG. 7 is a cross sectional view showing a plug of a frame piece incorporated in yet another electric stringed instrument according to the present invention, and

FIG. 8 is a cross sectional view showing a plug of a frame piece incorporated in still another electric stringed instrument according to the present invention.

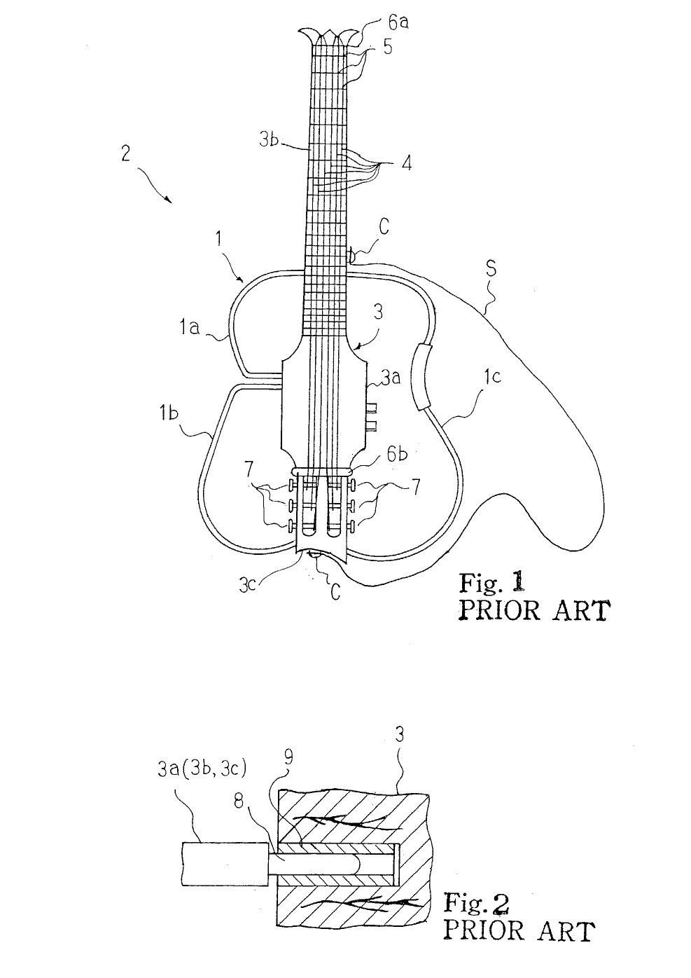

### DESCRIPTION OF THE PREFERRED EMBODIMENTS

First Embodiment

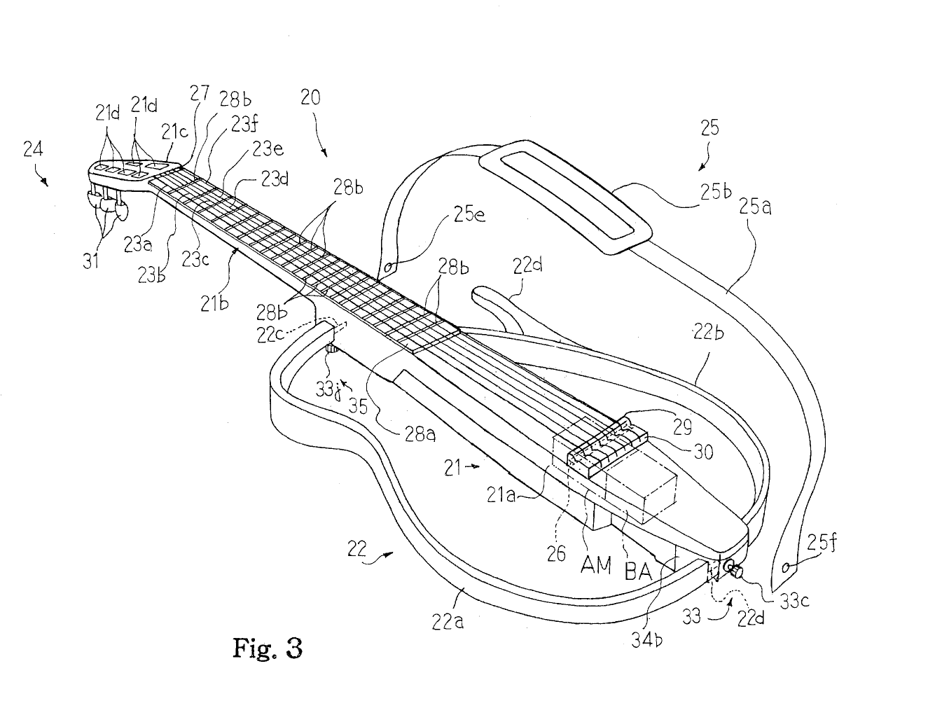

Referring to FIG. 3 of the drawings, an electric guitar 20 embodying the present invention largely comprises a trunk 21, a frame body 22, six strings 23a, 23b, 23c, 23d, 23e and 23f, an anchor 24, a strap 25 and a pickup 26. The trunk 21 is made of wood, and is partially thick and wide and partially thin and narrow. The thick wide portion is referred to as “boss”, and the boss is labeled with reference “21a”. On the other hand, the thin narrow portion is referred to as “neck”, and the neck is labeled with reference “21b”.

The neck 21b has an upper surface substantially coplanar with the upper surface of the boss 21a, and a leading end portion 21c of the neck 21b is downwardly bent from the remaining portion of the neck 21b. Six holes 21d are formed in the leading end portion 21c, and a fingerboard 28a is adhered to the upper surface of the remaining portion of the neck 21b. A bridge 27 is embedded in the neck 21b at the boundary between the leading end portion 21c and the remaining portion, and frets 28b are embedded in the finger board 28a at intervals. The frets 28b extend in the lateral direction of the fingerboard 28a, and are spaced from one another in the longitudinal direction of the fingerboard 28a.

A bridge 29 is embedded in a tailpiece 30, and is exposed to the upper surface of the tailpiece 30. The tailpiece 30 is fixed to the upper surface of the boss 21a. The pickup 26 is further embedded in the tailpiece 30, and vibrations of the bridge 29 are propagated to the pickup 26. The pickup 26 may be same as the pickups disclosed in Japan Patent Publication No. sho-62-33598 or any one of the pickups disclosed in Japan Utility Model Registration Nos. sho-61-46559 and sho-62-26797.

A hollow space is formed in the boss 21a, and a battery BA and pre-amplifier AM are received in the hollow space. The pre-amplifier AM is connected to the pickup 26, and is powered with the battery BA. The user manipulates switches (not shown) provided on the outer surface of the boss 21a for a tone control. The pre-amplifier AM is responsive to the instructions given through the switches for controlling the electric tone, balance and volume. The pre-amplifier AM is connected to a signal port (not shown), and the electric signal is output from the pre-amplifier AM through the signal port to a main amplifier (not shown).

The strings 23a to 23f are anchored to the tailpiece 30, and extend over the upper surface of the boss 21a and the fingerboard 28a. Six pegs 31 are provided at the leading end portion 21c, and are engaged with shafts (not shown) rotatable in the holes 21d. The strings 23a to 23f are connected at the other ends thereof to the shafts. The shafts are driven for rotation by means of the pegs 31 so that a user exerts tension on and removes the tension from the strings 23a to 23f by turning the pegs 31. When the user exerts the tension on the strings 23a to 23f, the strings 23a to 23f are pressed to the bridges 27 and 29 at both end portions thereof. However, the strings 23a to 23f float over the frets 28b between the bridges 27 and 29. Thus, the tailpiece 30, shafts and pegs 31 serve as the anchor 24.

The frame body 22 is made of metal, alloy, synthetic resin or wood, and is shaped like the outline of the rigid body of the prior art electric guitar. In this instance, the frame body 22 is separated into two frame pieces 22a and 22b. Although the frame piece 22b is fixed to the boss 21a, the frame piece 22a is detachably connected to the boss 21a.

The frame piece 22a is constricted at the intermediate portion, and plugs 22c project from both ends of the frame piece 22a. On the other hand, the frame piece 22b is gently curved, and a grip 22d projects from the frame piece 22b. The frame piece 22b is fixed to the side surface of the boss 21a close to the string 23f, and, accordingly, is not detachable. Holes are formed in the boss 21a, and are open to the outside on the other side surface close to the string 23a. The plugs 22c are inserted into the holes, and are fastened to the boss 21a by means of a fastener 33. The fastener 33 is shaped with the strap 25 as will be hereinafter described in more detail.

The strap 25 is popular to guitarists, and various sorts of straps are sold in the market. The strap 25 is one of the standard straps. The strap 25 has a flexible belt 25a and a pad 25b. Holes 25c are formed at both end portions of the flexible belt 25a. The pad 25b is slidable on the flexible belt 25a so that the user can adjust the pad 25b to his or her shoulder.

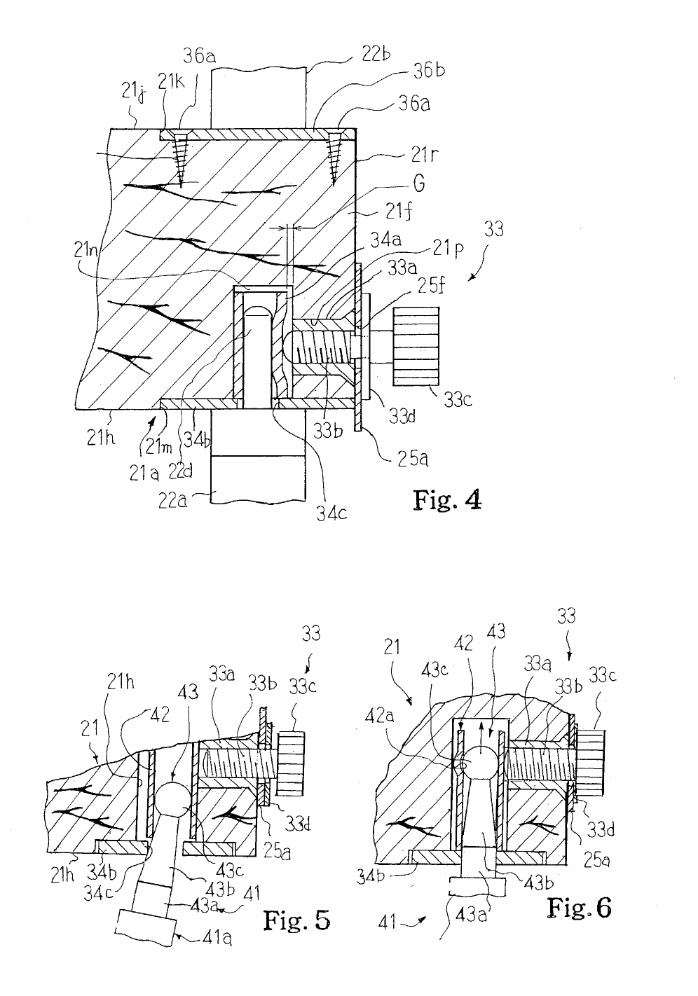

The frame piece 22a is detachably connected to both end portions of the boss 21a with the plugs 22c/22d, and the other frame piece 22b is fixed to both end portions of the boss 21a. The strap 25 is further connected to the rear/middle end portions of the trunk 21. FIG. 4 shows the rear end portion 21f of the boss 21a, to which the frame pieces 22a/22b and flexible belt 25a are connected. Since the frame pieces 22a/22b and flexible belt 25a are similarly connected at the other ends to the trunk 21, description is focused on the rear end portion. The side surfaces, which are respectively close to the strings 23a and 23f, are designated by reference numerals 21h and 21j in FIG. 4, respectively.

The rear end portion 21f is partially narrowed so that steps 21k and 21m take place between the wide sub-portion and the narrow sub-portion. The side surfaces of the narrow sub-portion are generally rectangular. A recess 21n is formed in the narrow sub-portion, and is open to the outside on the side surface. A sleeve 34a is loosely received in the recess 21n so that gap G takes place between the sleeve 34a and the inner surface defining the recess 21n. The sleeve 34a has an inner diameter larger than the outer diameter of the plug 22d. This means that the user can easily insert the plug 22d into the sleeve 34a. The sleeve 34a is made of elastically or resiliently deformable material. The sleeve 34a of the elastically or resiliently deformable material is to be recovered to the cylindrical shape after the elastic or resilient deformation equal to the gap G.

A generally rectangular plate 34b is attached to the side surface of the narrow sub-portion, and is fixed to the narrow sub-portion by means of wood screws (not shown). The generally rectangular plate 34b is made of metal or synthetic resin, and has the thickness approximately equal to the depth of the step 21m. For this reason, the outer surface of the plate 34b is coplanar with the side surface 21h. A through-hole 34c is formed in the generally rectangular plate 34b, and is aligned with the inner space of the sleeve 34a. The through-hole 34c has the inner diameter smaller in value than the outer diameter of the sleeve 34a so that the generally rectangular plate 34b prevents the sleeve 34a from dropping out from the recess 21n. However, the through-hole 34c is larger in diameter than the inner diameter of the sleeve 34a. The through-hole 34c permits the user to insert the plug 22 into the inner space of the sleeve 34a.

The fastener 33 includes a nut 33a, a bolt 33b, a knob 33c and a washer 33d. A hole 21p is further formed in the rear end portion 21f, and is open at one end to the recess 21h and at the other end to the outside on the rear end surface 21r. The nut 33a is inserted into the hole 21p, and is fixed to the rear end portion 21f. The nut 33a is equal in length to the hole 21p so that the both end surfaces are coplanar with the inner surface defining the recess 21n and the rear end surface 21r, respectively. The knob 33c is formed with serration, which prevents fingers from slippage. The knob 33c is fixed to the bolt 33b, and the bolt 33b is engaged with the nut 33a. The user pinches the knob 33c with fingers, and drives the knob 33c for rotation. Then, the bolt 33b deeply projects through the nut 33a into the recess 21n. As described hereinbefore, the sleeve 34a is elastically or resiliently deformable. When the bolt 33b is pressed to the sleeve 34a, the sleeve 34a is deformed, and is pressed onto the plug 22d. Thus, the bolt 33b is pressed through the sleeve 34a to the plug 22d, and prohibits the plug 22d from being pulled out.

Holes 25e and 25f are formed in both end portions of the flexible belt 25a. A bolt (not shown) passes through the hole 25e, and is engaged with a nut embedded in the trunk. The bolt presses a washer (not shown) to the flexible belt 25a, and the washer in turn presses the flexible belt 25a to the trunk 21.

Similarly, the bolt 33b passes through the hole 25f, and the washer 33d is pressed to the flexible belt 25a. The washer 33d presses the flexible belt 25a to the rear end surface 21r. Thus, the bolt 33b not only presses the sleeve 34a to the plug 22d but also pinches the flexible belt 25a between the rear end surface 21r and the washer 33d. This means that the fastener 33 is shared between the frame piece 22a and the flexible belt 25a. Only one knob 33c is seen around the rear end portion of the trunk 21, and the shared fastener 33 makes the outer appearance of the electric guitar simple.

The frame piece 22a is fastened to the front end sub-portion of the boss 21a as similar to the fastener 33 at the rear end portion 21f. Another fastener 35 is used for the plug 22c and the flexible belt 25a. The fastener 35 is similar in structure to the fastener 33, and is shared between the frame piece 22a and the flexible belt 25a. The plug 22c is inserted into a elastically or resiliently deformable sleeve embedded in the front end sub-portion of the boss 21a, and a nut is further embedded in the front end portion. A bolt with a knob 33j is pressed to the sleeve so that the deformed sleeve prevents the plug 22c from being dropped out. The knob 33j projects from the reverse surface of the trunk 21 as shown, and presses the other end portion of the flexible belt 25a to the reverse surface of the trunk 21 through a washer. Thus, the fastener 35 is also shared between the plug 22c and the flexible belt 25a.

The frame piece 22b is fixed to the rear end portion 21f by wood screws 36a. Generally rectangular plates 36b are fixed to both ends of the frame piece 22b, and is also made of metal or synthetic resin. Bolt holes are formed in the generally rectangular plate 36b at the rear end of the frame piece 22b, and the generally rectangular plate 36b is attached to the narrow sub-portion. The wood screws 36a are screwed through the holes into the rear end portion 21f, and presses the generally rectangular plate 36b to the side surface of the narrow sub-portion. The generally rectangular plate 36b has the thickness equal to the depth of the step 21k so that the outer surface of the plate 36b is coplanar with the side surface 21j. Though not shown in the drawings, a rectangular pit, which is corresponding to the generally rectangular plate at the front end of the frame piece 22b, is formed in the front portion of the boss 21a, and is open to the outside on the side surface 21j. The generally rectangular plate at the front end is snugly received in the rectangular pit, and is fixed to the boss 21f by means of the wood screws. Thus, the other frame piece 22b is fixed to the side surface 21j of the boss 21a by means of the wood screws 36a.

The trunk 21, to which the frame piece 22b has been already fixed, and frame piece 22a are assembled in the electric guitar as follows. First, the user inserts the plug 22d into the sleeve 34a through the hole 34c formed in the plate 34b. The other plug 22c is similarly inserted into the sleeve. The user inserts the bolt 33b through the hole 25f into the nut 33a, and screws the bolt 33b into the nut 33a. The bolt 33b spirally advances through the nut 33a, and the tip of the bolt 33b is brought into contact with the outer surface of the sleeve 34a. The user strongly drives the knob 33c for rotation, and presses the tip of the bolt 33b to the outer surface of the sleeve 34a. The sleeve 34a is elastically or resiliently deformed inwardly, and is pressed to the outer surface of the plug 22d. The plug 22d is further pressed to the inner surface of the sleeve 34a. Thus, the plug 22d is fastened to the inner surface of the sleeve 34a. The other plug 22c is also fastened to the inner surface of the sleeve so that the frame piece 22a is secured to the boss 21a.

As will be understood from the foregoing description, the fasteners 33/35 prevent the frame piece 22a from being unintentionally pulled out from the trunk 21. The user inserts the plugs into and pulls out them from the sleeves 34a, and turns the knobs 33c/33j for fastening or loosening the plugs 22c/22d. The assembling and disassembling works are not complicated. The bolts 33b are backward urged by the sleeves 34a so that the bolts 33b and nuts 33a are tightly meshed. Even if the user shakes the electric guitar 20 in the performance, the bolts 33b are never chattered.

The plugs 22c/22d are loosely received in the sleeves 34a. This means that the user easily inserts the plugs 22c/22d into the sleeves 34a. Even if the plugs 22d are inclined in the sleeves 34a, the bolts 33b cause the plugs 22c/22d to press the sleeves 34a to the inner surfaces defining the recesses 21n, and keep the plugs 22c/22d vertical.

Moreover, the fastener 33/35 are shared between the frame piece 22a and the strap 25. This results in the simple outer appearance of the electric guitar 20.

Second Embodiment

FIGS. 5 and 6 show a frame body 41 incorporated in another electric stringed instrument embodying the present invention. The electric stringed instrument implementing the second embodying the present invention is similar to the electric guitar 20. For this reason, parts of the electric stringed instrument are labeled with the references designating the corresponding parts of the electric guitar 20 without detailed description, and description is focused on the frame body 41.

The frame body 41 is shaped like the contour of a solid body, and plural frame pieces form in combination the frame body 41. One of the frame pieces 41a is detachably connected to the trunk 21 by means of fasteners 33, which is shared between the frame piece 41a and a strap 25. The other frame piece is similar to the frame piece 22b.

The sleeves 34a are replaced with sleeves 42, and a dent 42a is formed in each of the sleeves 42. The inner surface defining the dent 42a is rounded. The plug 22c/22d are replaced with plugs 43. The plug 43 has a straight boss portion 43a, a tapered portion 43b and a spherical portion 43c. The straight portion 43a is approximately equal in diameter to the hole 34c, and the spherical portion 43c has the radius of curvature equal to that of the dent 42a. Thus, a part of the spherical portion 43c is fit to the inner surface defining the dent 42a. The tapered portion 43b is between the straight portion 43a and the spherical portion 43c, and is decreased in cross section from the straight portion 43a toward the spherical portion 43c.

When a user assembles the frame piece 41a with the trunk 21, the plugs 43 are inserted through the hole 34c into the inner surface of the sleeves 42. Even if the user inclines the plugs 43 toward the side surface 21h, the tapered portions 43b slide the inner edges defining the holes 34c (see FIG. 5), and correct the attitude of the plugs 43. As a result, the straight portions 43 are snugly received in the holes 34c, and the spherical portions 43c reach the dents 42a as shown in FIG. 6.

The user engages the bolts 33b with the nuts 33a, and presses the sleeves 42 to the spherical portions 43c and the washers 33d and flexible belt 25a to the trunk 21.

The advantages of the first embodiment are also achieved by the electric stringed instrument implementing the second embodiment. Moreover, the user easily inserts the plugs 43 into the inner spaces of the sleeves 43 by virtue of the tapered portions 43b serving as a guide.

Third Embodiment

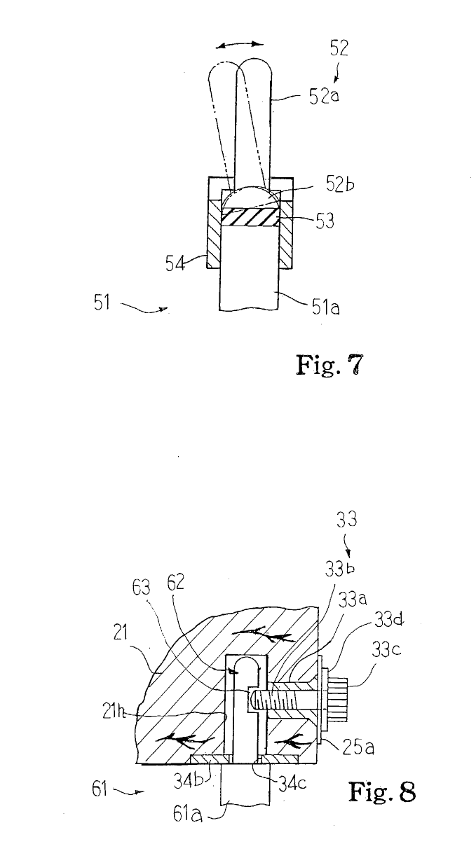

Turning to FIG. 7 of the drawings, a frame body 51 is incorporated in yet another electric stringed instrument embodying the present invention. The electric stringed instrument implementing the third embodying the present invention is similar to the electric guitar 20. For this reason, parts of the electric stringed instrument are labeled with the references designating the corresponding parts of the electric guitar 20 without detailed description, and description is focused on the frame body 51.

The frame body 51 is shaped like the contour of a solid body, and plural frame pieces form in combination the frame body 51. One of the frame pieces 51a is detachably connected to the trunk by means of fasteners, which is shared between the frame piece 51a and a strap 25. The other frame piece is similar to the frame piece 22b.

Plugs 52 project from both ends of the frame piece 51a, and each plug 52 has a projection 52a and a semi-spherical boss 52b. The projection 52a is integral with the semi-spherical boss 52b, and projects therefrom. A resilient block 53 is provided between the frame piece 51a and the semi-spherical boss 53 so that the projection 52a is inclinable by virtue of the resilient block 53. The plug 52 and resilient block 53 are integrated with the frame piece 51a by means of a retainer 54.

The projection 52a is inserted into the sleeve 34a, which is embedded in the trunk, and the sleeve 34a is pressed to the projection 52a by means of the fastener 33. The fastener 33 is shared with the strap 25, and all the advantages of the first embodiment are achieved by the electric stringed instrument implementing the third embodiment.

When a user assembles the frame piece 51a with the trunk 21, the user inserts the projection 52a through the hole 34c into the space defined in the sleeve 34a. Even if the user inclines the projection 52a, the resilient block 53 permits the projection 52a to incline as indicated by dots-and-dash line in FIG. 7 so that the user easily inserts the plug 52 into the sleeve 34a.

Fourth Embodiment

FIG. 8 shows a frame body 61 is incorporated in still another electric stringed instrument embodying the present invention. The electric stringed instrument implementing the fourth embodying the present invention is similar to the electric guitar 20. For this reason, parts of the electric stringed instrument are labeled with the references designating the corresponding parts of the electric guitar 20 without detailed description, and description is focused on the frame body 61.

The frame body 61 is shaped like the contour of a solid body, and plural frame pieces form in combination the frame body 61. One of the frame pieces 61a is detachably connected to the trunk 21 by means of fasteners 33/35, which are shared between the frame piece 61a and the strap 25. The other frame piece is similar to the frame piece 22b.

Plugs 62 project from both ends of the frame piece 61a, and dents 63 are formed in the plugs 62. Any sleeve is not received in the recesses 21h. When a user assembles the frame piece 61a with the trunk 21, the user inserts the plugs 62 into the recesses 21h, and directs the dents to the nuts 33b. The user turns the knobs 33c, and makes the bolts 33b engaged with the nuts 33a. The bolts 33b projects from the nuts 33a, and the tips of the bolts 33b reach the dents 63. The tips are pressed to the plugs 62. Thus, the bolts 33b prohibit the plugs 62 from being unintentionally pulled out from the recesses 21h.

The electric stringed instrument achieves all the advantages of the first embodiment. Any sleeve is not required for the electric stringed instrument. For this reason, the number of parts is decreased, and the production cost is reduced.

Although particular embodiments of the present invention have been shown and described, it will be apparent to those skilled in the art that various changes and modifications may be made without departing from the spirit and scope of the present invention.

The present invention is applicable to any sort of electric stringed instrument in so far as frame bodies are employed. For example, one of the electric stringed instruments is an electric base.

More than one frame pieces may be detachably connected to a trunk. Both of the frame pieces 22a/22b may be detachably connected to the trunk 21.

Holes may be formed in the plugs 62.

The frame body may have a contour like the outline of an acoustic stringed instrument.

The fasteners shared between the frame body and strap may be available for acoustic stringed instruments.

The pre-amplifier AM and power source BA may be provided outside of the electric stringed musical instrument. Only the pre-amplifier AM may be incorporated in the trunk of an electric stringed instrument.

What is claimed is:

1. A stringed musical instrument slung over a shoulder of a player for playing a piece of music, comprising:
a trunk having plural surfaces;
at least one string stretched over one of said plural surface between both end portions of said trunk;
a frame body having end portions inserted into recesses formed in said trunk and open to the outside on selected ones of said plural surfaces;
a strap making said player sling said stringed musical instrument over said shoulder; and
fasteners shared between said frame body and said strap for securing said end portions and both end portions of said strap to said trunk.

2. The stringed musical instrument as set forth in claim 1, in which a converter is provided on said trunk for converting vibrations of said at least one string to an electric signal.

3. The stringed musical instrument as set forth in claim 2, in which a pre-amplifier is further provided inside said trunk, and said converter is connected to said pre-amplifier.

4. The stringed musical instrument as set forth in claim 3, in which a power source is further provided inside said trunk, and supplies electric power to said converter and said pre-amplifier.

5. The stringed musical instrument as set forth in claim 1, in which elastically deformable sleeves are inserted in recesses formed in said trunk so as to receive said end portions, and said fasteners press said both end portions of said strap and said deformable sleeves to selected ones of said plural surfaces and inner surfaces of said trunk defining said recesses, respectively.

6. The stringed musical instrument as set forth in claim 5, in which each of said fasteners includes a first component part formed with a female screw and embedded in said trunk in such a manner as to be partially exposed to associated one of said recesses, a second component part formed with a male screw engaged with said female screw and projecting into said one of said recesses for pressing associated one of said elastically deformable sleeves to said projection and an inner surface defining said associated one of said recesses and a plate formed with a first hole permitting said second component part to pass and pressing one of said end portions of said strap to the associated one of said plural surfaces.

7. The stringed musical instrument as set forth in claim 6, further comprising plate members secured to said trunk for preventing said sleeves from being dropped out from said recesses and formed with respective second holes having an inner diameter larger than the inner diameter of the inner spaces defined in said sleeves and smaller than the outer diameter of said sleeves.

8. The stringed musical instrument as set forth in claim 7, in which said second holes guide said end portions into said sleeves.

9. The stringed musical instrument as set forth in claim 8, in which each of said end portions has a straight portion having a diameter equal to said inner diameter of associated one of said second holes, a spherical portion having a diameter less than said inner diameter of said associated one of said second holes and inserted into said inner space of the associated sleeve and a tapered portion having a cross section decreased from said straight portion to said spherical portion so that said tapered portion guides said straight portion to said associated one of said second holes.

10. The stringed musical instrument as set forth in claim 1, in which said end portions of said frame body are inclinable.

11. The stringed musical instrument as set forth in claim 10, in which each of said end portions has a projection received in a sleeve embedded in said trunk, a resilient block provided between an intermediate portion of said frame body and said projection and a retainer for connecting said projection and said resilient block to said intermediate portion so that said resilient block permits said projection to incline when a force is exerted on said projection.

12. The stringed musical instrument as set forth in claim 11, in which each of said fasteners includes a first component part formed with a female screw and embedded in said trunk in such a manner as to be partially exposed to associated one of said recesses, a second component part formed with a male screw and projecting into said one of said recesses for pressing said sleeve to an inner surface defining associated one of said recesses and said projection and a plate formed with a first hole permitting said second component part to pass and pressing one of said end portions of said strap to the associated one of said plural surfaces.

13. The stringed musical instrument as set forth in claim 1, in which recesses are formed in said trunk so as to receive said end portions, and said fasteners press said both end portions of said strap and said end portions of said frame body to selected ones of said plural surfaces and inner surfaces of said trunk defining said recesses, respectively.

14. The stringed musical instrument as set forth in claim 13, in which each of said fasteners includes a first component part formed with a female screw and embedded in said trunk in such a manner as to be partially exposed to associated one of said recesses, a second component part formed with a male screw engaged with said female screw and projecting into said one of said recesses for pressing one of said end portions to an inner surface defining said associated one of said recesses and a plate formed with a hole permitting said second component part to pass and pressing one of said end portions of said strap to the associated one of said plural surfaces.

15. The stringed musical instrument as set forth in claim 14, in which each of said end portions of said frame body is formed with a dent so that an end portion of said second member is inserted into said dent.
